(19) United States
(12) Patent Application Publication
(10) Pub. No.: US 2019/0305650 A1
(43) Pub. Date: Oct. 3, 2019

(54) MOTOR

(71) Applicant: NIDEC SERVO CORPORATION, Kiryu-shi (JP)

(72) Inventor: Hiroyuki TANAKA, Kiryu-shi (JP)

(21) Appl. No.: 16/274,288

(22) Filed: Feb. 13, 2019

(30) Foreign Application Priority Data
Mar. 30, 2018 (JP) 2018-069758

(51) Int. Cl. H02K 11/33; H02K 7/14; H02K 9/06; H02K 11/215; H02K 5/22

(52) U.S. Cl. CPC H02K 11/33; H02K 7/14; H02K 5/225; H02K 11/215; H02K 9/06

(57) ABSTRACT

A motor includes a motor case including a bottomed tubular first case portion and a bottomed tubular second case portion axially opposed to the first case portion, a stator sandwiched between the first and second case portions, and a rotor including a shaft radially opposed to the stator and extending along a central axis. A bearing provided in each of the first and second case portions and rotatably supporting the shaft about the central axis, a circuit board between the bearing provided either one of the first and second case portions and the stator, and electrically connected to a coil of the stator, and an impeller provided on the shaft inside the motor case and including blades in a circumferential direction around the central axis are included. The circuit board includes a shaft opening through which the shaft extends and a notch portion serially extending radially outward from the shaft opening.

### CROSS REFERENCE TO RELATED APPLICATIONS

This application claims the benefit of priority to Japanese Patent Application No. 2018-069758 filed on Mar. 30, 2018. The entire contents of this application are hereby incorporated herein by reference.

### BACKGROUND OF THE INVENTION

### 1. Field of the Invention

The present disclosure relates to a motor.

### 2. Description of the Related Art

A motor mounted on various household electrical appliances or the like includes a rotor that rotates together with a shaft, a stator that is provided radially outward of the rotor, and a motor case that houses the rotor and the stator. A conventional motor includes an impeller provided between a stator and a lid portion of a motor case and configured to rotate together with a shaft so as to suppress heat generation of the stator housed in the motor case, and a through hole provided in the lid portion of the motor case and axially overlapping with a plurality of blades provided in the impeller.

In the above-described motor, it is desired to achieve miniaturization, cost reduction, and improvement in assembly while securing cooling performance by the impeller.

### SUMMARY OF THE INVENTION

An example embodiment of the present disclosure includes a motor case including a bottomed tubular first case portion and a bottomed tubular second case portion axially opposed to the first case portion, a stator sandwiched between the first case portion and the second case portion, a rotor including a shaft radially opposed to the stator and extending along a central axis, a bearing provided in each of the first case portion and the second case portion and rotatably supporting the shaft about the central axis, a circuit board provided between the bearing provided either one of the first case portion and the second case portion and the stator, and electrically connected to a coil of the stator, and an impeller provided on the shaft inside the motor case and including a plurality of blades in a circumferential direction around the central axis, wherein the circuit board includes a shaft opening through which the shaft extends and a notch portion serially extending radially outward from the shaft opening.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view taken along the central axis of a motor according to an example embodiment of the present disclosure.

FIG. 2 is a perspective view showing a motor according to an example embodiment of the present disclosure.

FIG. 3 is a perspective view of a motor according to an example embodiment of the present disclosure as viewed from a direction different from that in FIG. 2.

FIG. 4 is a view showing a protruding portion provided on a first case portion and a second case portion of the motor according to an example embodiment of the present disclosure, and is a view of the first case portion and the second case portion as viewed from the axial direction.

FIG. 5 is a cross-sectional view of a principal portion showing the protruding portion provided on the first case portion and the second case portion of a motor according to an example embodiment of the present disclosure.

FIG. 6 is a perspective view showing a circuit board provided in a motor according to an example embodiment of the present disclosure.

FIG. 7 is a view of the circuit board provided in a motor according to an example embodiment of the present disclosure as viewed from the axial direction.

FIG. 8 is a view of a circuit board according to an example embodiment of the present disclosure as viewed from one side.

FIG. 9 is a view of a circuit board according to an example embodiment of the present disclosure as viewed from the other side.

FIG. 10 is a view showing lead wires connected to a motor according to an example embodiment of the present disclosure.

FIG. 11 is a cross-sectional view showing a state where a stator and a rotor have been incorporated in the first case portion in an assembly process of a motor according to an example embodiment of the present disclosure.

FIG. 12 is a cross-sectional view showing a state in which the circuit board has been incorporated in the assembly process of a motor according to an example embodiment of the present disclosure.

FIG. 13 is a cross-sectional view showing a configuration in a case where axial dimensions of the stator and the rotor are larger than those in FIG. 1 in a motor according to an example embodiment of the present disclosure.

### DETAILED DESCRIPTION OF THE PREFERRED EMBODIMENTS

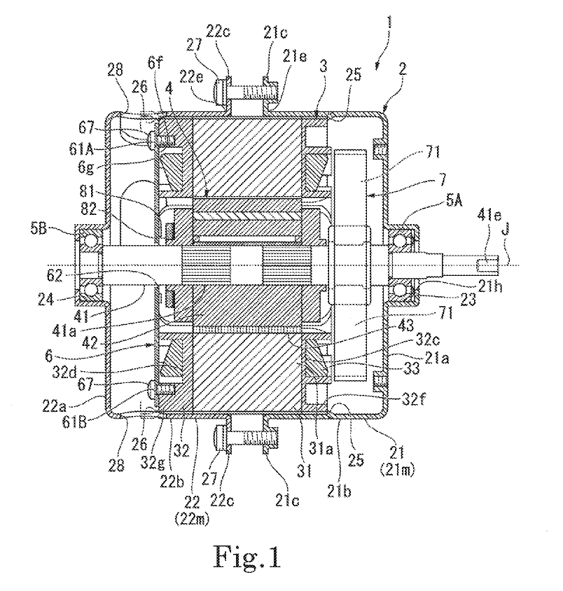

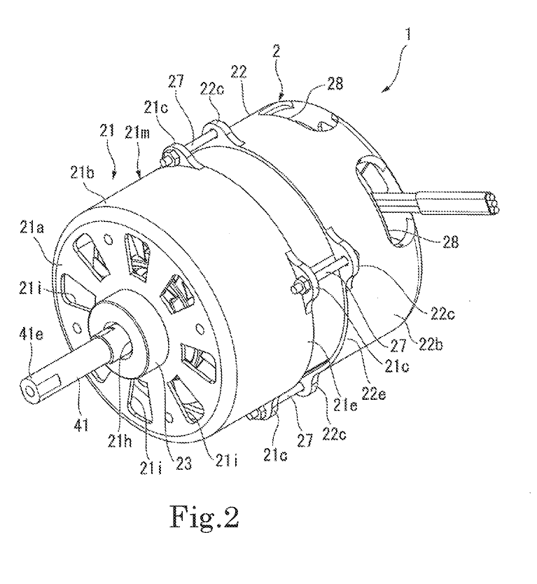

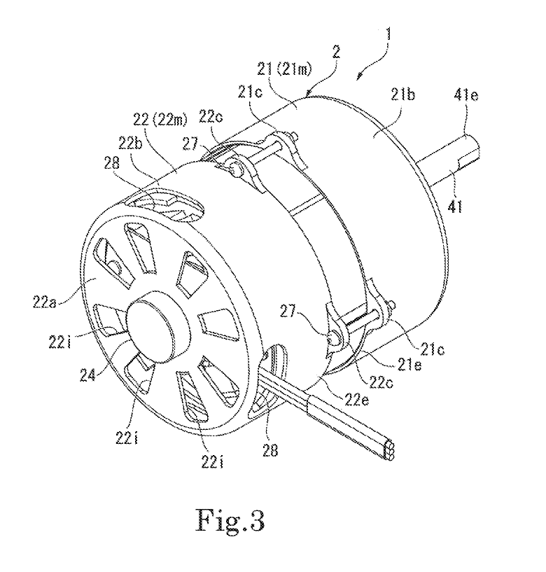

FIG. 1 is a cross-sectional view taken along the central axis of a motor according to an example embodiment. FIG. 2 is a perspective view showing the motor according to the embodiment. FIG. 3 is a perspective view of the motor according to the embodiment as viewed from a direction different from that in FIG. 2.

As shown in FIG. 1, a motor 1 of the present embodiment includes a motor case 2, a stator 3, a rotor 4, a circuit board 6, and an impeller 7.

The motor case 2 includes a first case portion 21 and a second case portion 22, which axially faces the first case portion 21. Each of the first case portion 21 and the second case portion is formed by pressing or the like a metal plate having conductivity such as an iron-based alloy. The first case portion 21 and the second case portion 22 may be made by die-casting a metal material having conductivity formed into a predetermined shape by casting.

As shown in FIG. 1 and FIG. 2, the first case portion 21 is provided on the other side (the right side in FIG. 1) in a central axis J direction. The first case portion 21 has a bottomed tubular case main body portion 21m.

The case main body portion 21m includes a first bottom plate portion 21a, a first peripheral wall portion 21b, and a first flange portion 21c as a single member.

The first bottom plate portion 21a is in a shape of a disk located in a plane orthogonal to the central axis J. A bearing holding portion 23 that holds an annular bearing 5A is provided in a central portion of the first bottom plate portion 21a. A shaft through hole 21h is provided in the central portion of the first bottom plate portion 21a. In addition, a plurality of introduction ports 21i are arranged on the first bottom plate portion 21a at equal intervals in the circumferential direction on a radially outer side of the shaft through hole 21h.

The first peripheral wall portion 21b has a cylindrical shape axially extending from the outer circumferential edge of the first bottom plate portion 21a. A first end portion 21e on the opposite side of the first bottom plate portion 21a in the first peripheral wall portion 21b opens toward the axially other side.

The first flange portion 21c extends radially outward from the first end portion 21e of the first peripheral wall portion 21b. The first flange portion 21c is provided at a plurality of locations at intervals in the circumferential direction. In the present embodiment, the first flange portions 21c are provided at four locations at equal intervals in the circumferential direction.

As shown in FIG. 1 and FIG. 3, the second case portion 22 is provided on one side in the central axis J direction. The second case portion 22 has a bottomed tubular case main body portion 22m. The case main body portion 22m includes a second bottom plate portion 22a, a second peripheral wall portion 22b, and a second flange portion 22c as a single member.

The second bottom plate portion 22a is in a shape of a disk located in a plane orthogonal to the central axis J. A bearing holding portion 24 that holds an annular bearing 5B is provided in a central portion of the second bottom plate portion 22a. A plurality of discharge ports 22i are arranged on the second bottom plate portion 22a at equal intervals in the circumferential direction on a radially outer side of the bearing holding portion 24.

The second peripheral wall portion 22b has a cylindrical shape axially extending from the outer circumferential edge of the second bottom plate portion 22a. A second end portion 22e on the opposite side of the second bottom plate portion 22a in the second peripheral wall portion 22b opens to the first case portion 21 side of the axially one side. A plurality of through holes 28 are arranged on the second peripheral wall portion 22b at equal intervals in the circumferential direction on the second bottom plate portion 22a axial side. The through hole 28 has a long hole shape radially penetrating the second peripheral wall portion 22b of the second case portion 22 and circumferentially continuing by a predetermined length.

The second flange portion 22c extends radially outward from the second end portion 22e of the second peripheral wall portion 22b. The second flange portion 22c is provided at a plurality of locations at intervals in the circumferential direction. In the present embodiment, the second flange portions 22c are provided at four locations at equal intervals in the circumferential direction.

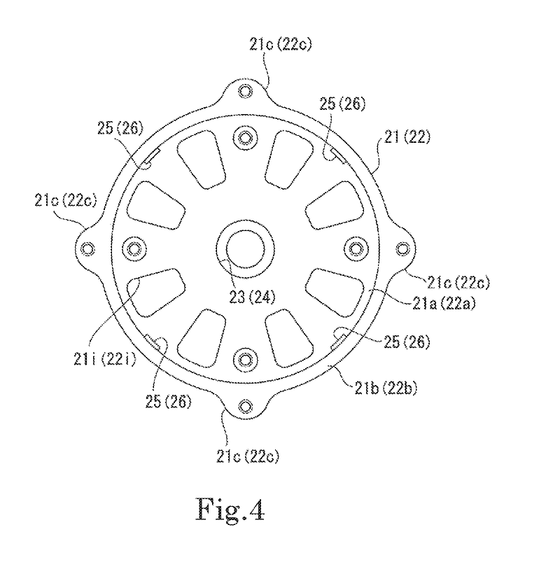

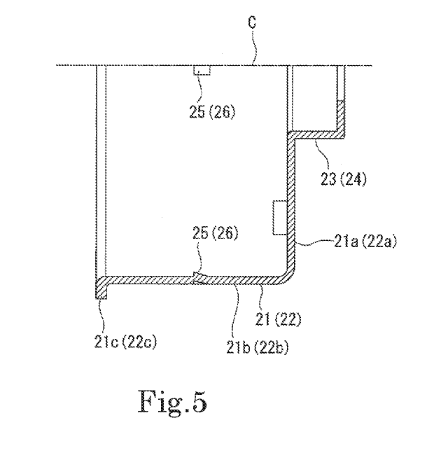

FIG. 4 is a view showing a protruding portion provided on a first case portion and a second case portion of the motor according to the embodiment, and is a view of the first case portion and the second case portion as viewed from the axial direction. FIG. 5 is a cross-sectional view of a principal part showing the protruding portion provided on the first case portion and the second case portion of the motor according to the embodiment.

As shown in FIG. 4 and FIG. 5, the first case portion 21 and the second case portion 22 respectively include protruding portions 25 and 26 projecting radially inward on the inner circumferential surfaces of the first peripheral wall portion 21b and the second peripheral wall portion 22b. The plurality of protruding portions 25 and 26 are provided at intervals in the circumferential direction. In the present embodiment, the protruding portions 25 and 26 are provided at four locations at intervals in the circumferential direction. The stator 3 inserted into the first case portion 21 and the second case portion 22 abuts against these protruding portions 25 and 26.

In the first case portion 21 and the second case portion 22, at least the first bottom plate portion 21a, the second bottom plate portion 22a, the first peripheral wall portion 21b, the second peripheral wall portion 22b, and the bearing holding portions 23 and 24 of the bottomed tubular case main body portions 21m and 22m have identical shapes to each other.

As shown in FIG. 1, the stator 3 includes a stator core 31, an insulator 32, and a coil 33. The stator core 31 is provided radially inward the motor case 2. The stator core 31 has a tubular shape as a whole by axially laminating a plurality of annular steel plates. The stator core 31 has a plurality of teeth 31a provided at equal intervals in the circumferential direction. Each of the teeth 31a extends radially inward. The insulator 32 has annular frame portions 32f and 32g on both axial sides of the stator core 31. The insulator 32 has teeth cover portions 32c and 32d that extend radially inward from the frame portions 32f and 32g and cover at least both axial end portions of each of the teeth 31a. Both axial end portions of the coil 33 are wound around the teeth 31a covered with the teeth cover portions 32c and 32d of the insulator 32.

In such the stator 3, the frame portions 32f and 32g of the insulator 32 provided on the both axial sides of the stator core 31 are sandwiched and held between the protruding portion 25 of the first case portion 21 and the protruding portion 26 of the second case portion 22. In a state where the stator 3 is sandwiched between the first case portion 21 and the second case portion 22, the first end portion 21e of the first peripheral wall portion 21b and the second end portion 22e of the second peripheral wall portion 22b axially face each other at intervals. In the present embodiment, the stator 3 is held by being sandwiched between the first case portion 21 and the second case portion 22.

It is to be noted that depending on the size of the stator 3, the first flange portion 21c and the second flange portion 22c may axially abut each other. The first flange portion 21c and the second flange portion 22c are coupled by a coupling member 27 such as a bolt and a nut.

The rotor 4 is provided radially inward of the stator 3 and radially faces the stator 3. The rotor 4 includes a shaft 41, a rotor core 42, and a permanent magnet 43. The shaft 41 axially extends along the central axis J. The shaft 41 is rotatably supported around the central axis J by the bearings 5A and 5B. The bearing 5A supporting one axial side of the shaft 41 is fitted into the bearing holding portion 23 of the first case portion 21. The bearing 5B supporting the other axial side of the shaft 41 is fitted into the bearing holding portion 24 of the second case portion 22. One end portion 41e of the shaft 41 projects outward of the central axis J direction from the motor case 2 through the shaft through hole 21h.

The rotor core 42 is provided radially outside the shaft 41. The rotor core 42 is fitted to a knurled portion 41a provided at an intermediate portion in the axial direction along the central axis J in the shaft 41 and rotates around the central axis J together with the shaft 41. The permanent magnet 43 is provided on the outer circumferential surface of the rotor core 42. The plurality of permanent magnets 43 are provided in the circumferential direction around the central axis J.

The impeller 7 is provided on the shaft 41 inside the motor case 2. The impeller 7 is provided in the first case portion 21 between the stator 3 and the rotor 4 and the first bottom plate portion 21a of the first case portion 21. The impeller 7 has a plurality of blades 71 in the circumferential direction. The impeller 7 rotates around the central axis J together with the shaft 41. The rotation of the impeller 7 introduces external air into the motor case 2 through the plurality of introduction ports 21i provided in the first bottom plate portion 21a of the first case portion 21, and generates wind flowing toward the other axial side. By this wind, the stator 3 and the rotor 4 in the motor case 2 are cooled down.

The circuit board 6 is provided inside the motor case 2. The circuit board 6 is provided between the bearing 5B provided on the second case portion 22 and the stator 3. The circuit board 6 has a plate shape perpendicular to the central axis J. The circuit board 6 is electrically connected to the coil 33 of the stator 3 and supplies a current to the coil 33.

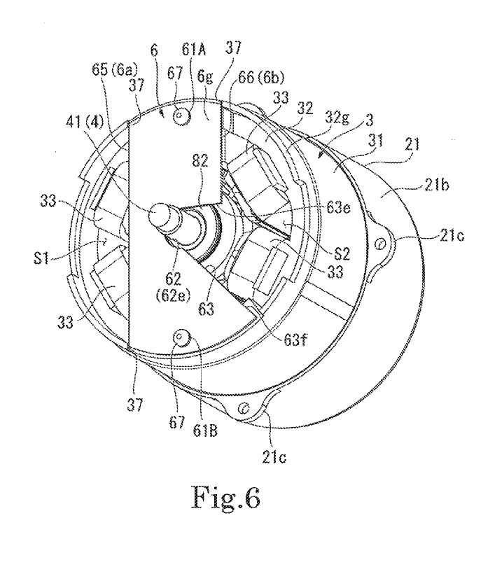

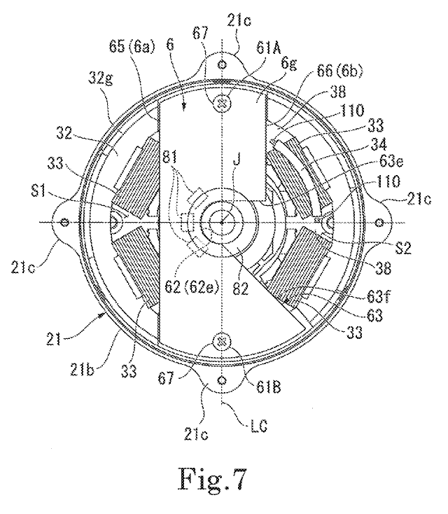

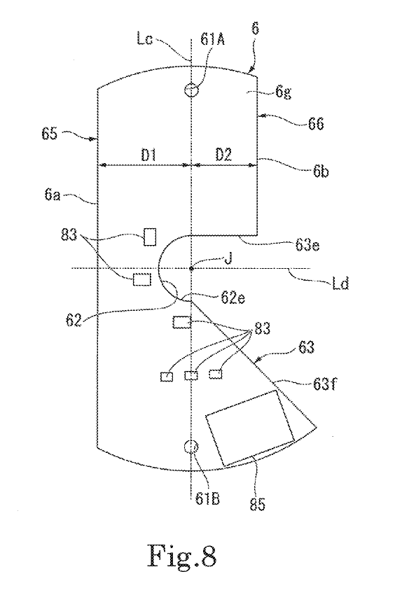

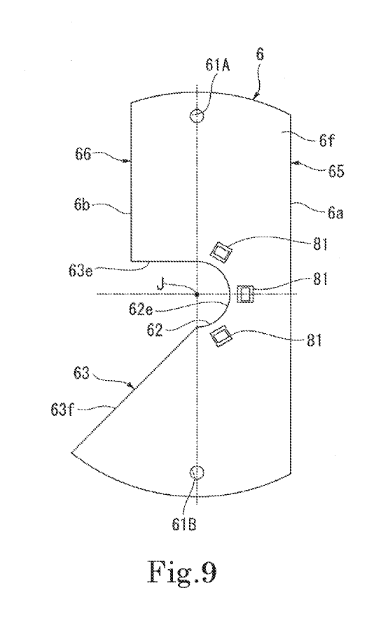

FIG. 6 is a perspective view showing a circuit board provided in the motor according to the embodiment. FIG. 7 is a view of the circuit board provided in the motor according to the embodiment as viewed from the axial direction. FIG. 8 is a view of the circuit board according to the embodiment as viewed from one side. FIG. 9 is a view of the circuit board according to the embodiment as viewed from the other side.

As shown in FIG. 6 to FIG. 9, the circuit board 6 includes fixing portions 61A and 61B, a shaft opening portion 62, a notch portion 63, and void generating portions 65 and 66.

The fixing portions 61A and 61B are provided on the circuit board 6. In the present embodiment, the fixing portions 61A and 61B are provided on both radial sides across the central axis J of the shaft 41. Each of the fixing portions 61A and 61B is a through hole penetrating the circuit board 6 in the board thickness direction. The circuit board 6 is fixed to the stator 3 by passing a screw 67 through each of the fixing portions 61A and 61B and fastening it to the frame portion 32g of the insulator 32 of the stator 3.

Here, as shown in FIG. 6, in the frame portion 32g of the insulator 32, a board housing recess portion 37 is arranged in a site where the outer circumferential portion of the circuit board 6 is housed. The board housing recess portion 37 is provided in the frame portion 32g so as to be recessed on one axial side and has a shape corresponding to the outer shape of the circuit board 6.

As shown in FIG. 6 to FIG. 9, the shaft opening portion 62 penetrates through the shaft 41 of the rotor 4 in the board thickness direction of the circuit board 6. An inner circumferential edge portion 62e of the shaft opening portion 62 has an arc shape. The shaft opening portion 62 has an inner diameter that is larger than the outer diameter of the shaft 41 and smaller than the outer diameter of the bearing 5B.

The notch portion 63 serially extends radially outward from the shaft opening portion 62 and opens radially outward of the circuit board 6. The notch portion 63 has an opening width equal to or larger than the outer diameter of the shaft 41. The opening width of the notch portion 63 gradually expands radially outward from the shaft opening portion 62. Circumferential edge portions 63e and 63f on both sides in the opening width direction of the notch portion 63 serially extend in the radial direction from the inner circumferential edge portion 62e of the shaft opening portion 62.

In the present embodiment, one circumferential edge portion 63e of the notch portion 63 extends along in a direction (perpendicular direction) forming an angle of 90° with respect to a center line Lc connecting the fixing portion 61A and the fixing portion 61B of the circuit board 6, for example. Further, the other circumferential edge portion 63f of the notch portion 63 extends along a direction (a direction rotated by 45° counterclockwise from the direction in which the circumferential edge portion 63e shown in FIG. 7 extends) forming an angle of 135° with respect to the above-described center line Lc.

The void generating portions 65 and 66 generate voids S1 and S2 between the void generating portions 65 and 66 and the inner circumferential surface of the motor case 2 in a site other than the notch portion 63. The void generating portion 65 is composed of a side edge portion 6a located on one side (the left side in FIG. 7) with respect to the center line Lc connecting the fixing portions 61A and 61B in the circuit board 6. The side edge portion 6a is in a linear shape extending in parallel with the center line Lc in the circuit board 6. The void generating portion 66 is composed of a side edge portion 6b located on the other side (the right side in FIG. 7) with respect to the center line Lc connecting the fixing portions 61A and 61B in the circuit board 6. The side edge portion 6b is in a linear shape extending in parallel with the center line Lc in the circuit board 6.

The void S1 is generated between the void generating portion 65 and the inner circumferential surface of the motor case 2 in a site other than the notch portion 63 inside of the motor case 2 by the side edge portion 6a (the void generating portion 65) as the void generating portion 65. The void S2 is generated between the void generating portion 66 and the inner circumferential surface of the motor case 2 inside of the motor case 2 by the side edge portion 6b as the void generating portion 66 and the notch portion 63.

Further, as shown in FIG. 8, the side edge portion 6a located on one side across the central axis J and the side edge portion 6b located on the other side thereacross are provided such that distances D1 and D2 from the center line Lc are different from each other. In the present embodiment, the distance D1 of the side edge portion 6a located on one side across the central axis J is larger than the distance D2 of the side edge portion 6b located on the other side across the central axis J. As a result, the circuit board 6 has an asymmetric shape on one side and the other side with respect to the center line Lc passing through the central axis J.

By providing the notch portion 63, the circuit board 6 has an asymmetric shape on one side and the other side with respect to the center line Ld passing through the central axis J orthogonal to the center line Lc.

Since the circuit board 6 thus has an asymmetrical shape, the worker can easily recognize the orientation of the circuit board 6 when incorporating the circuit board 6 in the assembly process of the motor 1.

On the surface of such the circuit board 6, various electronic components are mounted by soldering or the like. For instance, as shown in FIG. 9, a plurality of Hall elements (sensors) 81 are mounted on a surface 6f of the circuit board 6 facing the rotor 4 side on one axial side. The plurality of Hall elements 81 are arranged at intervals in the circumferential direction around the central axis J on the radially outside of the inner circumferential edge portion 62e of the shaft opening portion 62 on the circuit board 6. In the present embodiment, three Hall elements 81 are arranged at intervals of 60° around the central axis J.

As shown in FIG. 1, FIG. 6, and FIG. 7, an annular sensor magnet 82 is provided on the shaft 41 of the rotor 4 at a position axially facing the plurality of Hall elements 81. The sensor magnet 82 rotates around the central axis J together with the shaft 41. The Hall element 81 detects the rotation angle around the central axis J of the shaft 41 by detecting the change in the magnetic flux of the sensor magnet 82 rotating together with the shaft 41.

As shown in FIG. 8, for example, a plurality of capacitors 83 are arranged on a surface 6g of the circuit board 6 facing the other axial side.

In addition, a connector connecting portion 85 is provided on the surface 6g of the circuit board 6. The connector connecting portion 85 is arranged in a position in the vicinity of the fixing portion 61B so as to radially face the through hole 28 (see FIG. 1 and FIG. 3) provided in the second case portion 22. The connector connecting portion 85 opens radially outward.

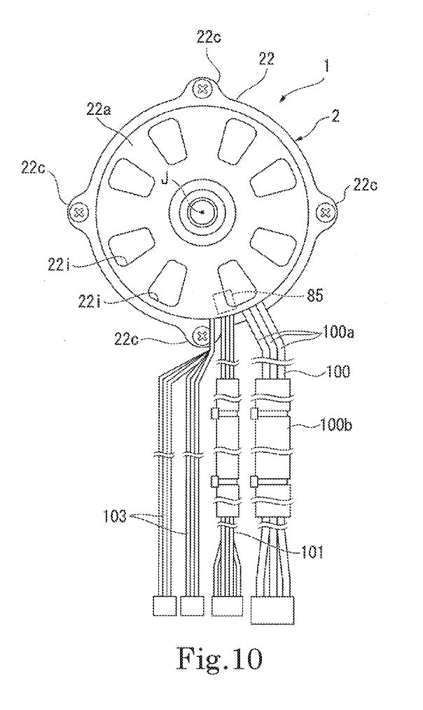

FIG. 10 is a view showing lead wires connected to the motor according to the embodiment.

To such the motor 1, a coil lead wire 100 connected to the coil 33 of the stator 3 and a lead wire 101 connected to the connector connecting portion 85 are connected. The coil lead wire 100 is directly connected to the coil 33 of each phase of the U phase, the V phase, and the W phase in the stator 3. The coil lead wire 100 is provided so as to extend from the outside to the inside of the motor case 2 through the through hole 28 provided in the second case portion 22. The lead wire 101 has a connector (not shown) at its tip portion. This connector (not shown) can be inserted into and removed from the connector connecting portion 85 opening radially outward through the through hole 28.

In addition, as shown in FIG. 7, in the stator 3, a common line 34 constituting a neutral point of the coil 33 of each phase of the U-phase, the V-phase and the W-phase is arranged in a position facing the side edge portion 6b of the circuit board 6 and the void S2 between the notch portion 63 and the inner circumferential surface of the motor case 2.

Further, the motor 1 includes a thermal protector 110 that stops the operation when the temperature of the coil 33 of the stator 3 becomes equal to or higher than a preset upper limit temperature. The thermal protector 110 is arranged in a slot 38 arranged between the coils 33 circumferentially adjacent to each other in the stator 3. In the present embodiment, the thermal protector 110 is arranged in the two slots 38 arranged in a position facing the side edge portion 6b of the circuit board 6 and the void S2 between the notch portion 63 and the inner circumferential surface of the motor case 2. As shown in FIG. 10, the lead wire 103 connected to the thermal protector 110 is guided to the outside of the motor case 2 through the through hole 28.

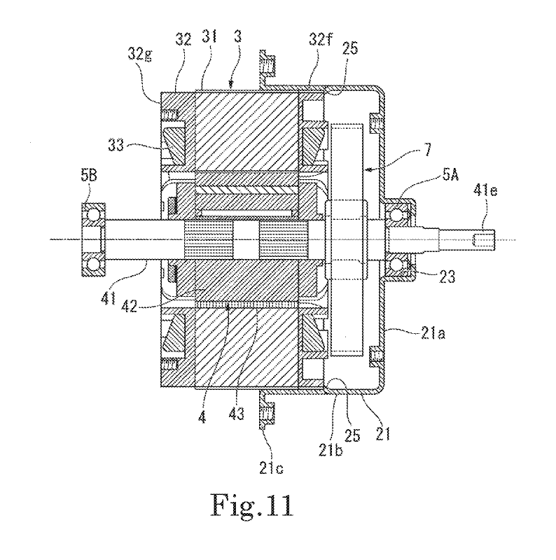

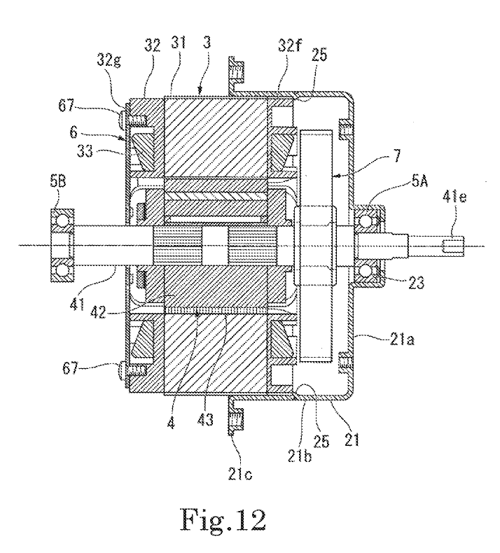

FIG. 11 is a cross-sectional view showing a state where the stator and the rotor have been incorporated in the first case portion in the assembly process of the motor according to the embodiment. FIG. 12 is a cross-sectional view showing a state in which the circuit board has been incorporated in the assembly process of the motor according to the embodiment.

In order to assemble the motor 1 as described above, the bearings 5A and 5B are press-fitted into both end portions of the shaft 41 of the rotor 4 in advance. Further, the impeller 7 is mounted on one axial side of the rotor 4.

Next, as shown in FIG. 11, the stator 3 and the rotor 4 are incorporated in the first case portion 21. The stator 3 axially abuts the frame portion 32f of the insulator 32 provided on one axial side of the stator core 31 to the protruding portion of the first case portion 21. The rotor 4 press-fits the bearing 5A into the bearing holding portion 23 of the first case portion 21.

Subsequently, as shown in FIG. 12, the circuit board 6 is incorporated. For this purpose, the circuit board 6 is brought closer to the radial inside from the radial outside of the shaft 41, and the shaft 41 is passed through the shaft opening portion 62 via the notch portion 63. Subsequently, the screws 67 are passed through the fixing portions 61A and 61B of the circuit board and fastened to the frame portion 32g of the insulator 32. Thereby, the circuit board 6 is fixed to the stator 3.

Next, as shown in FIG. 1, the second case portion 22 is caused to cover a part of the stator 3 and a part of the rotor 4 that project from the first case portion 21 and the circuit board 6. At this time, the protruding portion 26 of the second case portion 22 axially abuts against the frame portion 32g of the insulator 32 provided on the other axial side of the stator core 31. Thereby, the stator 3 is axially sandwiched between the first case portion 21 and the second case portion 22. In this state, the first case portion 21 and the second case portion 22 leave a gap in the axial direction.

Thereafter, the first flange portion 21c of the first case portion 21 and the second flange portion 22c of the second case portion 22 are coupled by the coupling member 27 formed of bolts and nuts, thereby completing assembly of the motor 1.

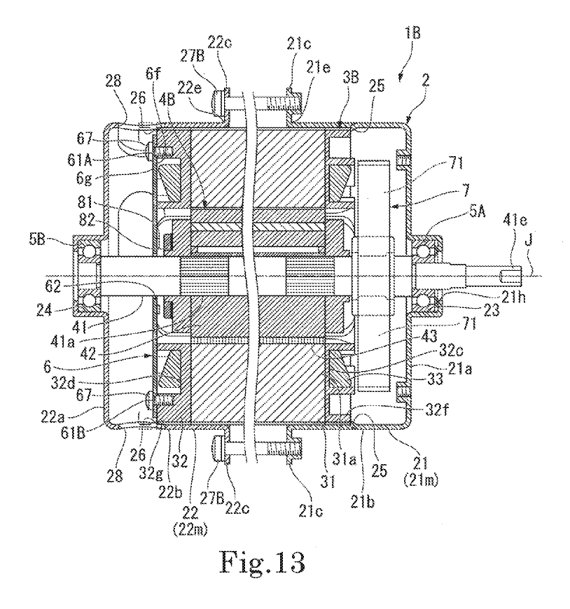

FIG. 13 is a cross-sectional view showing a configuration in a case where axial dimensions of the stator and the rotor are larger than those in FIG. 1 in the motor according to the embodiment.

When changing the output performance of the motor 1, the motor 1 as described above changes the axial dimensions of the stator 3 and the rotor 4. For example, as shown in FIG. 13, when the axial lengths of a stator 3B and a rotor 4B are larger than the stator 3 and the rotor 4 shown in FIG. 1, the stator 3B is sandwiched between the first case portion 21 and the second case portion 22 constituting the motor case 2 in common with the case of FIG. 1. Then, as compared with the case of FIG. 1, the axial interval between the first case portion 21 and the second case portion 22 sandwiching the stator 3 having the increased axial dimension. Therefore, the length of the coupling member 27 coupling the first flange portion 21c of the first case portion 21 and the second flange portion 22c of the second case portion 22 is increased.

In this manner, in a case of manufacturing a plurality of types of motors 1B having different axial directions of the stator 3 and the rotor 4, only the length of a coupling member 27B is changed while the first case portion 21 and the second case portion 22 are formed as common parts.

According to the present embodiment, the stator 3 is held by being sandwiched between the first case portion 21 and the second case portion 22 constituting the motor case 2. Thereby, the motor 1 can be axially downsized. Further, in order to change the performance of the motor 1, when the axial dimensions of the stator 3 and the rotor 4 are increased or decreased, the axial interval between the first case portion 21 and the second case portion 22 sandwiching the stator 3 may be varied. Therefore, in a case of manufacturing a plurality of types of motors 1 having different axial directions of the stator 3 and the rotor 4, it is possible to use the first case portion 21 and the second case portion 22 as common parts. As a result, versatility of the first case portion 21 and the second case portion 22 is enhanced, and cost reduction can be achieved.

Further, the circuit board 6 is serially provided with the notch portion 63 radially outward from the shaft opening portion 62. This notch portion 63 allows the flow path of the wind generated by the impeller 7 to increase. Accordingly, the cooling performance of the stator 3 by the impeller 7 can be improved.

Further, the inclusion of the notch portion 63 allows the shaft 41 to be inserted into the shaft opening portion 62 through the notch portion 63 by bringing the circuit board 6 close to the shaft 41 from the radial outside to the radial inside thereof when incorporating the circuit board 6. Therefore, even if the shaft 41 is provided with the bearings 5A and 5B having larger diameters than the shaft 41, it is possible to incorporate the circuit board 6 from the radial direction without interfering with the bearings 5A and 5B, thereby improving the ease of assembly.

Here, in a case of incorporating the circuit board 6 from the axial direction, the shaft opening portion 62 needs to have a larger inner diameter than the bearings 5A and 5B having larger diameters than the shaft 41. On the other hand, according to the present embodiment, the diameter of the shaft opening portion 62 can be reduced by enabling the circuit board 6 to be incorporated from the radial direction. Due to this, an electronic component to be mounted on the circuit board 6 radially outside the shaft opening portion 62 can be arranged in a position close to the shaft 41 radially inside, thereby allowing the circuit board 6 to be miniaturized. As a result, the gap between the circuit board 6 and the motor case 2 can be enlarged, the flow path of the wind generated by the impeller 7 can be increased, and the cooling performance can be enhanced.

In this manner, according to the motor 1, it is possible to achieve miniaturization, cost reduction, and improvement in ease of assembly while ensuring the cooling performance by the impeller 7.

As described above, according to the present embodiment, the first case portion 21 and the second case portion 22 leave a gap in the axial direction and the first flange portion 21c and the second flange portion 22c coupled with each other by the coupling member 27.

According to this configuration, the length of the coupling member 27 may be changed in a case where the axial interval between the first case portion 21 and the second case portion 22 sandwiching the stator 3 by increasing or decreasing the axial dimensions of the stator 3 and the rotor 4 is varied, in order to change the performance of the motor 1.

Therefore, in a case of manufacturing a plurality of types of motors 1 having different axial directions of the stator 3 and the rotor 4, only the length of the coupling member 27 may be changed for the motor case 2, thereby achieving cost reduction.

Further, according to the present embodiment, the first case portion 21 and the second case portion 22 include the protruding portions 25 and 26 that project radially inward and abut against the axial end portion of the stator 3.

According to this configuration, it is possible to sandwich and hold the stator 3 from both axial sides with the protruding portion 25 of the first case portion 21 and the protruding portion 26 of the second case portion 22 can. At the time of assembling the motor 1, the stator 3, the first case portion 21, and the second case portion 22 are positioned only by inserting the stator 3 into the inside of the first case portion and the second case portion 22 and abutting against the protruding portions 25 and 26. Therefore, the ease of assembly of the motor 1 is improved.

Further, according to the present embodiment, the notch portion 63 has an opening width equal to or larger than the outer diameter of the shaft 41.

According to this configuration, since the circuit board 6 is incorporated, when bringing the circuit board 6 close to the shaft 41 from the radial outside to the radial inside thereof and passing the shaft 41 through the notch portion 63, it is possible to suppress interference with the shaft 41. Accordingly, incorporation of the circuit board 6 can be smoothly carried out, thereby improving the ease of assembly.

Further, according to the present embodiment, the notch portion 63 is provided so that the opening width gradually expands radially outward from the shaft opening portion 62.

According to this configuration, since the circuit board 6 is incorporated, when bringing the circuit board 6 close to the shaft 41 from the radial outside to the radial inside thereof and passing the shaft 41 through the notch portion 63, it is possible to guide the shaft 41 to the shaft opening portion 62 while more securely suppressing interference with the shaft 41. Accordingly, incorporation of the circuit board 6 can be smoothly carried out, thereby further improving the ease of assembly.

Further, according to the present embodiment, the circuit board 6 has the void generating portions 65 and 66 that generate the voids S1 and S2 between the circuit board 6 and the inner circumferential surface of the motor case 2 in a site other than the notch portion 63.

According to this configuration, the flow path of the wind generated by the impeller 7 can be increased. Accordingly, the cooling performance of the stator 3 by the impeller 7 can be further improved.

Further, according to the present embodiment, the circuit board 6 has a shape that is asymmetric on one side and the other side across the central axis J of the shaft 41.

According to this configuration, the worker can easily recognize the orientation of the circuit board 6 when incorporating the circuit board 6. Therefore, it is possible to prevent erroneous assembly in which the orientation of the circuit board is incorrectly assembled, thereby improving quality and workability.

Further, according to the present embodiment, the circuit board 6 includes the Hall element 81 that detects the rotation angle of the shaft 41 on the inner circumferential edge portion 62e of the shaft opening portion 62.

According to this configuration, it is possible to reduce the size of the sensor magnet 82 that detects the Hall element 81 by providing the Hall element 81 on the circumferential edge portion of the shaft opening portion 62 of which the diameter is reduced by providing the notch portion 63, thereby allowing to contribute to cost reduction.

Further, according to the present embodiment, a part of the stator 3 is provided with the board housing recess portion 37 that houses the circuit board 6.

According to this configuration, the worker can easily recognize the orientation of the circuit board 6 when incorporating the circuit board 6. Therefore, it is possible to prevent erroneous assembly in which the orientation of the circuit board is incorrectly assembled, thereby improving quality and workability.

Further, according to the present embodiment, the connector connecting portion 85 to which a connector 101c is connected opens so as to face radially outward and communicate with the through hole 28.

According to this configuration, the connector 101c can be connected to the connector connecting portion 85 from the radial outside through the through hole 28. Thereby, it is possible to easily carry out connection of the connector 101c to the motor 1.

Further, according to the present embodiment, the connector connecting portion 85 is arranged in the vicinity of the fixing portion 61A. According to this configuration, the connector connecting portion 85 is firmly held and when an external force is applied to the connector connecting portion 85 at the time of connecting the connector 101c to the connector connecting portion 85, displacement of the connector connecting portion 85 caused by deformation of the circuit board 6 is suppressed. Therefore, it is possible to securely carry out connection of the connector 101c.

Further, according to the present embodiment, in the first case portion 21 and the second case portion 22, at least the case main body portions 21m and 22m and the bearing holding portions 23 and 24, which hold the bearings 5A and 5B, have identical shapes.

According to this configuration, it becomes possible also to manufacture the first case portion 21 and the second case portion 22 with a common metal mold, and it is possible to achieve cost reduction.

While an embodiment of the present disclosure has been described above, each of the features, combination of the features, and so on in the embodiment are merely an example, and an addition, elimination, substitution of a feature, and other modifications may be made without departing from the scope of the present disclosure. The present disclosure is not limited by the embodiment.

For example, the use application of the motor 1 described in the above embodiment is not particularly limited.

While in the embodiment described above, the circuit board 6 is fixed to the frame portion 32g of the insulator 32 of the stator 3 by the fixing portions 61A and 61B, the present invention is not limited thereto. As long as the circuit board 6 can be fixed to the stator 3, its fixing structure can be appropriately modified.

Further, in the embodiment described above, the shape of the circuit board 6 can be appropriately modified. For example, the location and shape of the side edge portions 6a and 6b can be appropriately modified within a range that does not interfere with the arrangement of electronic components mounted on the circuit board 6.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor, comprising:
a motor case including a bottomed tubular first case portion and a bottomed tubular second case portion axially opposed to the first case portion;
a stator sandwiched between the first case portion and the second case portion;
a rotor including a shaft radially opposed to the stator and extending along a central axis;
a bearing provided in each of the first case portion and the second case portion and rotatably supporting the shaft about the central axis;
a circuit board provided between the bearing provided in either one of the first case portion and the second case portion and the stator, and electrically connected to a coil of the stator; and
an impeller provided on the shaft inside the motor case and including a plurality of blades in a circumferential direction around the central axis; wherein
the circuit board includes a shaft opening through which the shaft extends and a notch portion serially extending radially outward from the shaft opening and having an opening width equal to or larger than an outer diameter of the shaft.

2. The motor according to claim 1, wherein
the first case portion and the second case portion each include a flange portion extending radially outward; and
a gap is provided in an axial direction between the flange portions of the first and second case portions.

3. The motor according to claim 1, wherein the first case portion and the second case portion include protruding portions projecting radially inward and abutting against an axial end portion of the stator.

4. The motor according to claim 1, wherein the opening width of the notch portion expands radially outward from the shaft opening portion.

5. The motor according to claim 1, wherein the circuit board includes a void generating portion generating a void between the circuit board and an inner circumferential surface of the motor case at a location other than a location of the notch portion.

6. The motor according to claim 1, wherein the circuit board has an asymmetric shape on one side and another side across the central axis of the shaft.

7. The motor according to claim 1, wherein the circuit board includes a sensor to detect a rotation angle of the shaft at a circumferential edge portion of the shaft opening portion.

8. The motor according to claim 1, wherein a portion of the stator is provided with a board housing recess portion housing the circuit board.

9. The motor according to claim 1, wherein
the motor case includes a through hole penetrating inside and outside of the motor case; and
the circuit board includes a connector connecting portion to which a connector is connected and the connector connecting portion opens so as to face radially outward and communicate with the through hole.

10. The motor according to claim 9, wherein
the circuit board includes a plurality of fixing portions to be fixed to the stator; and
the connector connecting portion is arranged at or adjacent to any one of the fixing portions.

11. The motor according to claim 1, wherein in the first case portion and the second case portion, at least bottomed tubular case main body portions and bearing holding portions provided in the case main body portions and holding the bearings have identical shapes.
